(19) United States
(12) Patent Application Publication
(10) Pub. No.: US 2006/0253276 A1
(43) Pub. Date: Nov. 9, 2006

(54) Method and apparatus for coding audio signal

(75) Inventors: Tae Ik Kang, Gyeong-do (KR); Jin Kyu Choi, Seoul (KR); Keun Sup Lee, Seoul (KR); Young Cheol Park, Gangwon-do (KR); Dae Hee Youn, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/395,838

(22) Filed: Mar. 31, 2006

(30) Foreign Application Priority Data
Mar. 31, 2005 (KR) 10-2005-0027029

(51) Int. Cl. G10L 19/00

(52) U.S. Cl. 704/200.1

(57) ABSTRACT

An audio coding method and apparatus capable of improving efficiency of a MPEG-4 AAC (Moving Picture Expert Group-4 Advanced Audio Coding) process are disclosed. The audio coding method and apparatus reduce the number of calculations of an audio coding algorithm to improve efficiency of an audio coding process. Specifically, the audio coding method and apparatus reduce the number of calculations required for a Psychoacoustic model process of the MPEG-4 AAC algorithm capable of coding an audio signal.

This application claims the benefit of Korean Patent Application No. 10-2005-0027029, filed on Mar. 31, 2005, which is hereby incorporated by reference as if fully set forth herein.

### BACKGROUND OF THE INVENTION

1. Field of the Invention

The present invention relates to a method and apparatus for coding an audio signal, and more particularly to a method and apparatus for coding an audio signal to increase process efficiency of a Moving Picture Expert Group-4 Advanced Audio Coding (MPEG-4 AAC) scheme.

2. Discussion of the Related Art

A Moving Picture Expert Group (MPEG) audio standard plays an important role in the storage and transmission of audio signals in a system capable of providing multimedia services, such as a Digital Audio Broadcasting (DAB) service, an Internet phone service or an Audio On Demand (AOD) service. An MPEG audio coding algorithm based on an MPEG audio standard is used to compress audio signals without losing subjective sound quality so as to reduce the channel capacity required for storing and transmitting the audio signals.

Among a plurality of MPEG audio coding algorithms, MPEG-4 AAC (Moving Picture Group-4 Advanced Audio Coding) scheme is the latest such systemized coding scheme and supports the highest compression rate and the best sound quality. Audio compression techniques have been rapidly developed according to this MPEG scheme.

Psychoacoustic theory capable of effectively removing noise using human auditory characteristics has made great contributions to the rapid development of audio compression techniques. During the audio coding process, a maximum allowable noise amount for each frequency is calculated according to the complicated Psychoacoustic theory process.

FIG. 1 is a block diagram illustrating a conventional audio coding apparatus for coding audio signals. Specifically, FIG. 1 illustrates an apparatus recommended in ISO/IEC 14496-3, which is indicative of the standard technique associated with the MPEG-4 AAC. As illustrated in FIG. 1, the conventional audio coding apparatus includes a Modified Discrete Cosine Transform (MDCT) block 10, a Fast Fourier Transform (FFT) block 20, a Psychoacoustic model block 30, a coding efficiency improvement block 40, a Quantization and Bit Allocation block 50, and a Huffman coding block 60.

The MDCT block 10 receives a time-domain signal and transforms the received signal into a frequency-domain signal in a coding process. The FFT block 20 receives an audio signal, performs an FFT process on the received audio signal, and outputs transform coefficients. The coding efficiency improvement block 40 improves coding (i.e., compression) efficiency associated with signal characteristics using a plurality of methods, such as, a Temporal Noise Shaping (TNS), a Joint Stereo, a Long Term Prediction (LTP) for improving a compression performance associated with periodic signals and Perceptual Noise Suppression (PNS) for improving compression efficiency associated with a noise component. It should be noted that the above-mentioned components contained in the coding efficiency improvement block 40 have been defined in the MPEG-4 AAC standard.

The Psychoacoustic model block 30 analyzes perceptual characteristics of the audio signal and determines a maximum allowable quantization noise amount for each frequency of the analyzed audio signal. The Psychoacoustic model block 30 uses coefficients received from the FFT block 20.

The Quantization and Bit Allocation block 50 performs quantization and bit allocation on the received signals. The quantization process minimizes an amount of noise amount perceived by a human being in consideration of both an SNR (Signal-to-Noise Ratio) associated with an output signal of the coding efficiency improvement block 40 and an output value of the Psychoacoustic model block 30. Additionally, bit allocation is optimized, such that the SNR associated with the output signal of the coding efficiency improvement block 40 is less than the maximum allowable quantization noise amount of the output value of the Psychoacoustic model block 30 according to the optimized bit allocation. It should be noted that constituent components of the above-mentioned quantization and bit allocation block 50 have been defined in the MPEG-4 AAC standard.

It is well known to those skilled in the art that the Huffman coding block 60 allows the output signal of the above-mentioned Quantization and Bit Allocation block 50 to be coded without any loss. At the same time, the Psychoacoustic model block 30 analyzes perceptual characteristics of the audio signal transformed into the frequency-domain signal, such that it requires a specific process for transforming an input audio signal into the frequency-domain signal.

Specifically, the current MPEG recommendation has defined the necessity of an additional FFT for use in the Psychoacoustic model. As illustrated in FIG. 1, the conventional audio coding apparatus contains FFT block 20.

However, among the number of calculations performed in the blocks in the conventional apparatus illustrated in FIG. 1 and, specifically among the number of calculations performed in each block according to the MPEG-4 AAC algorithm, the Psychoacoustic model process returns about one half of the calculations. Specifically, the FFT of Psychoacoustic model process requires many calculations.

If a low-speed processor is used, the MPEG-4 AAC algorithm required for the conventional approach cannot be driven in real time. On the other hand, if a high-performance processor having a high-calculation performance is used, the MPEG-4 AAC algorithm can be driven in real time. However, a high-performance processor has disadvantageous power-consumption.

Therefore, an improved method is needed that is capable of reducing the number of calculations in driving the MPEG-4 AAC algorithm. The present invention addresses these and other needs.

### SUMMARY OF THE INVENTION

The present invention is directed to an audio coding method and apparatus that substantially obviates one or more problems due to limitations and disadvantages of the related art. An object of the present invention is to provide an audio coding method and apparatus for reducing the number of calculations of an audio coding algorithm in order to improve efficiency of an audio coding process. Another object of the present invention is to provide an audio coding method and apparatus for reducing the number of calculations required for a Psychoacoustic model process of an MPEG-4 AAC algorithm capable of coding an audio signal.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an audio coding method comprising the steps of: a) transforming an input time-domain audio signal to a frequency-domain audio signal using a Modified Discrete Cosine Transform (MDCT); b) transforming the input time-domain audio signal using a Modified Discrete Sine Transform (MDST); c) shifting a combination of the transform result of the MDCT and the transform result of the MDST by a predetermined value; d) performing a Finite Impulse Response (FIR) filtering on the shifted result; and e) determining a maximum allowable quantization noise amount for each frequency by applying the filtering result to a Psychoacoustic model.

Preferably, the filtering result corresponds to a first coefficient and a second coefficient of a Fast Fourier Transform (FFT) result associated with the input audio signal.

In another aspect of the present invention, there is provided an audio coding apparatus comprising: a Modified Discrete Cosine Transform (MDCT) block for transforming a time-domain audio signal into a frequency-domain audio signal; and a Psychoacoustic model block for determining a maximum allowable quantization noise amount for each frequency using the transform result received from the MDCT block.

Preferably, the apparatus further comprises a Modified Discrete Sine Transform (MDST) block for performing an MDST process on the time-domain audio signal.

Preferably, the apparatus further comprises a shifting block for shifting a combination of a transform result of the MDCT block and a transform result of the MDST block by a predetermined value.

Preferably, the apparatus further comprises a Finite Impulse Response (FIR) filter for performing a primary FIR filtering on the output result of the shifting block, and providing the Psychoacoustic model block with the FIR filtering result.

Preferably, the filtering result obtained by the FIR filter corresponds to a first coefficient and a second coefficient of a Fast Fourier Transform (FFT) result associated with the audio signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a block diagram illustrating a conventional audio coding apparatus.

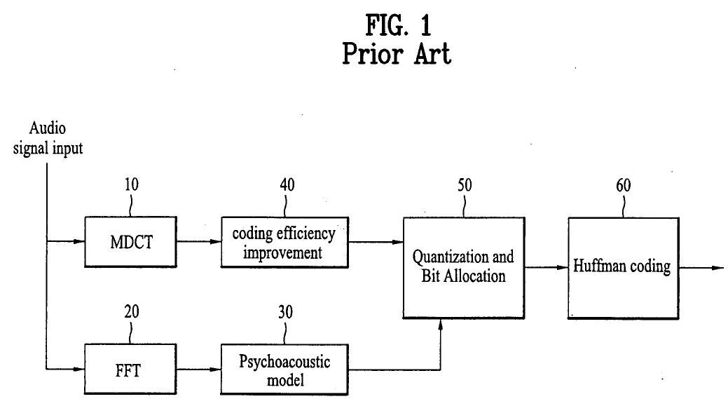

FIG. 2 is a block diagram illustrating an audio coding apparatus in accordance with a one embodiment of the present invention.

FIG. 3 is a flow chart illustrating a Psychoacoustic model process capable of coding an audio signal according to one embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A method and apparatus for coding an audio signal according to the present invention will be described with reference to the annexed drawings. The present invention aims to reduce the number of calculations required in the FFT process for performing the Psychoacoustic model process of the MPEG-4 AAC algorithm.

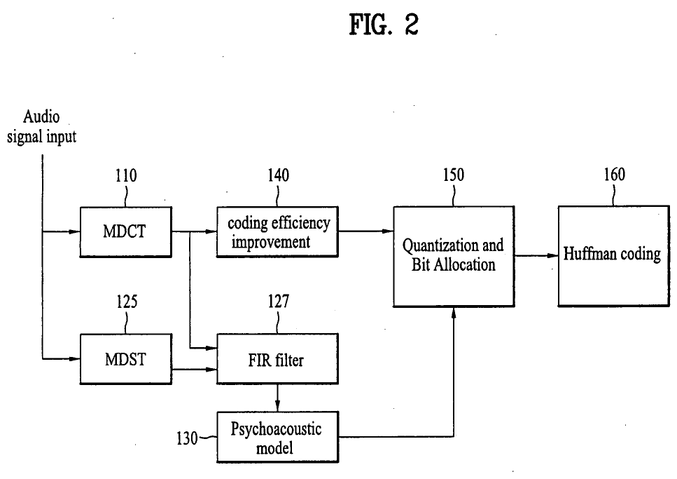

FIG. 2 is a block diagram illustrating an audio coding apparatus in accordance with a one embodiment of the present invention. As illustrated in FIG. 2, the audio coding apparatus according to the present invention includes an MDCT block 110, a Modified Discrete Sine Transform (MDST) block 125, a Finite Impulse Response (FIR) filter 127, a Psychoacoustic model block 130, a coding efficiency improvement block 140, a Quantization and Bit Allocation block 150 and a Huffman coding block 160.

The MDCT block 110 receives a time-domain audio signal and transforms the received audio signal into a frequency-domain signal in order to perform the coding process. The MDST block 125 performs an MDST on the received time-domain audio signal. The FIR filter 127 performs a primary FIR filtering and transmits the FIR-filtering result to the Psychoacoustic model block 130. The Psychoacoustic model block 130 analyzes perceptual characteristics of the audio signal and determines a maximum allowable quantization noise amount for each frequency of the analyzed audio signal. The Psychoacoustic model block 130 uses the transform result of the MDCT block 110, the transform result of the MDST block 125 and the filtering result of the FIR filter 127.

The Psychoacoustic model block 130 must use coefficients obtained by the FFT result. Therefore, if the FIR filter 127 performs the primary FIR filtering on the combination of the transform result of the MDCT block 110 and the transform result of the MDST block 125, and the primary FIR filtering result corresponds to the FFT result associated with the received audio signal, coding performance is not affected by the primary FIR filtering result. This is illustrated by Equation 1.

$$FFT \{ x ( n ) \} = [ ( {X}_{c} ( k ) - j {X}_{s} ( k ) ) \cdot exp ( j \frac{2 π}{N} {n}_{0} k ) ] * FFT \{ exp ( j \frac{2 π}{N} {k}_{0} n ) \} \qquad [ Equation 1 ]$$

With reference to Equation 1, x(n) represents an input audio signal, FFT{x(n)} represents the FFT result of the input audio signal, Xc(k) represents the transform result of the MDCT block 110, Xs(k) represents the transform result of the MDST block 125 and n₀ and k₀ represent constants for use in the MDCT block. Additionally, symbol (*) represents a circular convolution, the character (n) represents a sample index of the input audio signal, the character (k) represents a frequency index, the character (N) represents window length of a transform window and

$$exp ( j \frac{2 π}{N} {n}_{0} k )$$

represents the n₀ shifting result.

The audio coding apparatus further includes a shifting block (not shown) for shifting the combination of the transform results of the MDCT block 110 and the MDST block 125 by a predetermined value.

The shifting block performs n₀ shifting. The FIR filter 127 performs the primary FIR filtering on the output signal of the shifting block and transmits the FIR filtering result to the Psychoacoustic model block 130. The MDST block 125 and the FIR filter 127 obtain the above-mentioned FFT result.

As illustrated in Equation 1, the combination of the MDCT result and the MDST result of the input audio signal is calculated and the circular convolution of calculated combination result is obtained. However, since the circular convolution greatly affects the number of calculations, the present invention performs an approximation process using the primary FIR filtering generated by the FIR filter 127 to reduce the number of circular convolution calculations. In other words, the approximation of a plurality of circular convolution calculations is performed by the primary FIR filtering generated by the FIR filter 127.

At the same time, a window applied to the input audio signal for the FFT is different from a window applied to the input audio signal for the MDCT. Considering the different windows applied to the FFT and the MDCT, Equation 1 is transformed into Equation 2. Equation 2 is obtained by applying a Hann window to Equation 1 and compensates for different windows applied to individual input audio signals of the FFT and the MDCT.

$$\begin{matrix}FFT \{ x ( n ) {h}_{H} ( n ) \} = FFT \{ x ( n ) {h}_{s} ( n ) \cdot \frac{{h}_{H} ( n )}{{h}_{s} ( n )} \} \\ = [ ( {X}_{c} ( k ) - j {X}_{s} ( k ) ) \cdot exp ( j \frac{2 π}{N} {n}_{0} k ) ] * \\ FFT \{ exp ( j \frac{2 π}{N} {k}_{0} n ) \frac{{h}_{H} ( n )}{{h}_{s} ( n )} \}\end{matrix} \qquad [ Equation 2 ]$$

In Equation 2, hₛ(n) represents a sine window for use in the MDCT and hH(n) represents a Hann window used primarily for the Psychoacoustic model input process. The approximation must be performed by the primary FIR filtering in order to reduce the number of circular convolution calculations, as illustrated in Equation 2.

A right term of the circular convolution shown in FIG. 2 has a constant value(s) associated with a frequency index (k), such that the constant values are implemented in the form of a table. The FIR filtering result, which is the output signal or the primary FIR filtering result of the FIR filter 12, can be represented by Equation 3:

$${\sum }_{i = 0}^{1} {a}_{i} t [ k - 1 ] \qquad [ Equation 3 ]$$

In Equation 3, t(k) is denoted by

$$t ( k ) = [ ( {X}_{c} ( k ) - j {X}_{s} ( k ) ) \cdot exp ( j \frac{2 π}{N} {n}_{0} k ) ] ,$$

a₀ represents a first coefficient value of the

$$FFT \{ exp ( j \frac{2 π}{N} {k}_{0} n ) \}$$

and a₁ represents a second coefficient value of the

$$FFT \{ exp ( j \frac{2 π}{N} {k}_{0} n ) \} .$$

The coding efficiency improvement block 140 is composed of a plurality of components prescribed in the MPEG-4 AAC standard and improves coding (i.e., compression) efficiency according to signal characteristics. The components in the coding efficiency improvement block 140 are a TNS (Temporal Noise Shaping) component, a Joint Stereo component, a LTP (Long Term Prediction) component and a PNS (Perceptual Noise Suppression).

The Quantization and Bit Allocation block 150, which is defined in the MPEG-4 AAC standard, performs quantization and bit allocation on the received signal. The quantization process minimizes an amount of noise perceived by a human being in consideration of both an SNR (Signal-to-Noise Ratio) associated with an output signal of the coding efficiency improvement block 140 and an output value of the Psychoacoustic model block 130. Additionally, bit allocation is optimized, such that the SNR associated with the output signal of the coding efficiency improvement block 140 is less than the maximum allowable quantization noise amount of the output value of the Psychoacoustic model block 130 according to the optimized bit allocation.

The Huffman coding block 160 allows the output signal of the Quantization and Bit Allocation block 150 to be coded without any loss.

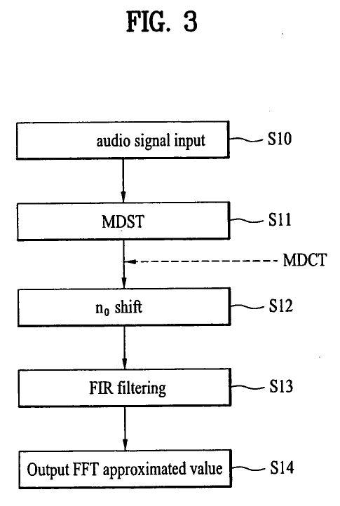

FIG. 3 is a flow chart illustrating a Psychoacoustic model process capable of coding an audio signal according to the present invention. As illustrated in FIG. 3, a time-domain audio signal received in the audio coding apparatus at step S10 is assumed to be equal to 2048 samples.

The audio signal is transformed into another signal by the MDST block 125 at step S11. The MDCT block 127 transforms the input audio signal into a frequency-domain audio signal and the transform result is combined with the MDST transform result, such that the combination result X_{c}(k)−jXₛ(k) is acquired.

The combination result X_{c}(k)−jXₛ(k) is successively multiplied by a specific value

$$exp ( j \frac{2 π}{N} {n}_{0} k )$$

as illustrated in Equation 1. In other words, the combination of the two transform results is shifted by a predetermined value of n₀ at step S12 and a spectrum is moved on a time axis by a predetermined value equal to the n₀ shift.

The primary FIR filtering is performed on the n₀ shift result at step S13. The FIR filtering result is acquired when the input audio signal approximates the FFT result.

The present invention does not apply a plurality of coefficients calculated by the FFT result to the Psychoacoustic model, but rather uses only first and second coefficients of the FFT result. In other words, the primary FIR filtering result is equal to the FFT-approximated value. The Psychoacoustic model block 130 uses the FFT-approximated value at step S14.

At the same time, the present invention performs the aforementioned approximation to substitute for the FFT result, thereby resulting in the occurrence of unexpected errors. However, the errors do not greatly affect the audio coding process.

A predetermined number N*(log2N+1)/4 of real-number multiplications and a predetermined number of N*(log2N−1)/4 are required to calculate a high-speed MDST associated with N samples. The number of multiplications required for the n₀ shifting process is 3N/2 and the number of additions required for the n₀ shifting process is 3N/2. The number of multiplications required for the FIR filtering process is 3N and the number of additions required for the FIR filtering process is 7N/2.

Therefore, the total number of multiplication/addition calculations for the Psychoacoustic model is denoted by N*log2N+19N/2. The number of calculations required for a general FFT is denoted by 4N*(log2N−1)+8.

Therefore, assuming that the FFT process is associated with input audio signals composed of 2048 samples, the number of calculations required for the FIR filtering according to the present invention occupies about 51% of the number of calculations required for the FFT process. Therefore, the present invention can considerably reduce the total number of calculations for an audio coding process.

It will be apparent to those skilled in the art that various modifications and variations can be made in the present invention without departing from the spirit or scope of the inventions. Therefore, it is intended that the present invention covers the modifications and variations of this invention provided they come within the scope of the appended claims and their equivalents.

What is claimed is:

1. An audio coding apparatus comprising:
a Modified Discrete Cosine Transform (MDCT) block adapted to transform a time-domain audio signal into a frequency-domain audio signal; and
a Psychoacoustic model block adapted determine a maximum allowable quantization noise amount for each frequency using the transform result received from the MDCT block.

2. The apparatus according to claim 1, further comprising:
a Modified Discrete Sine Transform (MDST) block adapted to perform an MDST process on the time-domain audio signal.

3. The apparatus according to claim 2, further comprising:
a shifting block adapted to shift a combination of a transform result of the MDCT block and a transform result of the MDST block by a predetermined value.

4. The apparatus according to claim 3, further comprising:
a Finite Impulse Response (FIR) filter adapted to perform primary FIR filtering on the output result of the shifting block and provide the Psychoacoustic model block with a result of the FIR filtering.

5. The apparatus according to claim 4, wherein the filtering result obtained by the FIR filter corresponds to a first coefficient and a second coefficient of a Fast Fourier Transform (FFT) result associated with the audio signal.

6. The apparatus according to claim 5, wherein the FFT result is represented by a first equation
$$FFT \{ x ( n ) \} = [ ( {X}_{c} ( k ) - j {X}_{s} ( k ) ) \cdot exp ( j \frac{2 π}{N} {n}_{0} k ) ] * FFT \{ exp ( j \frac{2 π}{N} {k}_{0} n ) \}$$
formed by the transform result of the MDCT block and the transform result of the MDST block,
wherein the symbol * denotes a circular convolution calculated using a primary FIR filtering generated by the FIR filter, x(n) represents an input audio signal, FFT{x(n)} represents an FFT result of the input audio signal, Xc(k) represents the transform result of the MDCT block, Xs(k) represents the transform result of the MDST block, n₀ and k₀ represent constants for use in the MDCT block, n represents a sample index of the input audio signal, N represents a window length of a transform window and
$$exp ( j \frac{2 π}{N} {n}_{0} k )$$
represents the shifting result of the shifting block.

7. The apparatus according to claim 6, wherein the output result of the FIR filter is represented by a second equation
$${\sum }_{i = 0}^{1} {a}_{i} t [ k - i ]$$
and is equal to the primary FIR filtering result,
wherein a₀ represents a first coefficient value of the
$$FFT \{ exp ( j \frac{2 π}{N} {k}_{0} n ) \} ,$$
a₁ represents a second coefficient value of the
$$FFT \{ exp ( j \frac{2 π}{N} {k}_{0} n ) \}$$
and t(k) is denoted by
$$t ( k ) = [ ( {X}_{c} ( k ) - j {X}_{s} ( k ) ) \cdot exp ( j \frac{2 π}{N} {n}_{0} k ) ] .$$

8. The apparatus according to claim 6, wherein the first equation represents the FFT result using a Hann window when a window of the FFT is different from a window of the MDCT.

9. The apparatus according to claim 6, wherein the first equation, representing the FFT result and to which a Hann window is applied, is changed to a third equation denoted by:
$$\begin{matrix}FFT \{ x ( n ) {h}_{H} ( n ) \} = FFT \{ x ( n ) {h}_{s} ( n ) \cdot \frac{{h}_{H} ( n )}{{h}_{s} ( n )} \} \\ = [ ( {X}_{c} ( k ) - j {X}_{s} ( k ) ) \cdot exp ( j \frac{2 π}{N} {n}_{0} k ) ] * \\ FFT ( exp ( j \frac{2 π}{N} {k}_{0} n ) \frac{{h}_{H} ( n )}{{h}_{s} ( n )} \}\end{matrix}$$
such that the third equation compensates for different windows applied to the FFT and the MDCT block.

10. An audio coding method comprising:
transforming an input time-domain audio signal into a frequency-domain audio signal using a Modified Discrete Cosine Transform (MDCT);
transforming the input time-domain audio signal using a Modified Discrete Sine Transform (MDST); and
determining a maximum allowable quantization noise amount for each frequency by applying the transform results of the MDCT and the MDST to a Psychoacoustic model.

11. The method according to claim 10, further comprising:
shifting a combination of the transform result of the MDCT and the transform result of the MDST by a predetermined value; and
performing a Finite Impulse Response (FIR) filtering on the shifted result.

12. The method according to claim 11, further comprising determining the maximum allowable quantization noise amount is according to the filtering result.

13. The method according to claim 11, further comprising performing primary FIR filtering.

14. The method according to claim 11, wherein the filtering result corresponds to a first coefficient and a second coefficient of a Fast Fourier Transform (FFT) result associated with the input audio signal.

15. The method according to claim 14, wherein the FFT result is represented by a first equation
$$FFT \{ x ( n ) \} = [ ( {X}_{c} ( k ) - j {X}_{s} ( k ) ) \cdot exp ( j \frac{2 π}{N} {n}_{0} k ) ] * FFT \{ exp ( j \frac{2 π}{N} {k}_{0} n ) \}$$
formed by the transform result of the MDCT and the transform result of the MDST,
wherein the symbol * denotes a circular convolution calculated using primary FIR filtering, x(n) represents an input audio signal, FFT{x(n)} represents an FFT result of the input audio signal, Xc(k) represents the transform result of the MDCT, Xs(k) represents the transform result of the MDST, n₀ and k₀ represent constants for use in the MDCT, n represents a sample index of the input audio signal, N represents a window length of a transform window and
$$exp ( j \frac{2 π}{N} {n}_{0} k )$$
represents the shifted result.

16. The method according to claim 15, wherein the output result of the FIR filter is represented by a second equation
$${\sum }_{i = 0}^{1} {a}_{i} t [ k - i ]$$
and is equal to the primary FIR filtering result,
wherein a₀ represents a first coefficient value of the
$$FFT \{ exp ( j \frac{2 π}{N} {k}_{0} n ) \} ,$$
a₁ represents a second coefficient value of
$$FFT \{ exp ( j \frac{2 π}{N} {k}_{0} n ) \}$$
and t(k) is denoted by
$$t ( k ) = [ ( {X}_{c} ( k ) - j {X}_{s} ( k ) ) \cdot exp ( j \frac{2 π}{N} {n}_{0} k ) ] .$$

17. The method according to claim 15, wherein the first equation represents the FFT result using a Hann window when a window of the FFT is different from a window of the MDCT.

18. The method according to claim 15, wherein the first equation, representing the FFT result and to which a Hann window is applied, is changed to a third equation denoted by:
$$\begin{matrix}FFT \{ x ( n ) {h}_{H} ( n ) \} = FFT \{ x ( n ) {h}_{s} ( n ) \cdot \frac{{h}_{H} ( n )}{{h}_{s} ( n )} \} \\ = [ ( {X}_{c} ( k ) - j {X}_{s} ( k ) ) \cdot exp ( j \frac{2 π}{N} {n}_{0} k ) ] * \\ FFT \{ exp ( j \frac{2 π}{N} {k}_{0} n ) \frac{{h}_{H} ( n )}{{h}_{s} ( n )} \}\end{matrix}$$
such that the third equation compensates for different windows applied to the FFT and the MDCT block.
